(19) United States
(12) Patent Application Publication
(10) Pub. No.: US 2024/0108534 A1
(43) Pub. Date: Apr. 4, 2024

(54) SYSTEMS INCLUDING MASSAGE SUBASSEMBLIES FOR A SEAT

(71) Applicant: LEAR CORPORATION, Southfield, MI (US)

(72) Inventors: Daniel Josefsson, Falkoping (SE); Tyler Washington, Southfield, MI (US); Grzegorz Kasperczyk, Warszawa (PL)

(21) Appl. No.: 18/236,019

(22) Filed: Aug. 21, 2023

Related U.S. Application Data
(60) Provisional application No. 63/411,400, filed on Sep. 29, 2022.

(51) Int. Cl. A61H 9/00

(52) U.S. Cl. CPC A61H 9/0078; A61H 2201/0149; A61H 2201/1246; A61H 2201/5056; A61H 2205/106

(57) ABSTRACT

This disclosure relates to systems including massage subassemblies for a seat, such as a seat of an automobile. The massage subassemblies are configured to provide a relatively intense massage. In an example, a system includes a first source of fluid, and a first bladder fluidly coupled to the first source of fluid and configured to be selectively inflated with the first source of fluid. The example system further includes a second source of fluid and a second bladder fluidly coupled to the second source of fluid and configured to be selectively inflated with the second source of fluid. Further, in the example, the second bladder projects from a surface of the first bladder, and the second bladder is fluidly isolated from the first bladder.

### RELATED APPLICATIONS

This application claims the benefit of U.S. Provisional Application No. 63/411,400, filed Sep. 29, 2022, the entirety of which is herein incorporated by reference.

### BACKGROUND

Massage assemblies for automobile seats are known to include inflatable massage subassemblies, which may be referred to as cells. Massage assemblies include fluid supply lines, a valve arrangement, and a controller. The individual massage subassemblies may be inflated in a particular sequence to provide a desired massage effect.

### BRIEF DESCRIPTION OF THE DRAWINGS

FIG. 1 is a perspective, partial cut-away view of an example seat.

FIG. 2 schematically illustrates some components of a fluid supply system relative to a plurality of massage subassemblies.

FIG. 3 schematically illustrates some other components of a fluid supply system relative to the massage subassemblies.

FIG. 4 is a side view of an example massage subassembly.

FIG. 5A is a top view of a first configuration of the example massage subassembly.

FIG. 5B is a top view of a second configuration of the example massage subassembly.

FIG. 6 is a perspective view illustrating an arrangement of two different types of massage subassemblies.

FIG. 7 is a side view of another example massage subassembly.

FIG. 8 schematically illustrates a fluid supply system relative to a plurality of the massage subassemblies of FIG. 7.

FIG. 9 is a top view of the example massage subassembly of FIG. 7.

FIG. 10 is a side view of another example massage subassembly.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

This disclosure relates to systems including massage subassemblies for a seat, such as a seat of an automobile. Among other benefits, which will be appreciated from the below description, the massage subassemblies of this disclosure are capable of providing a relatively intense massage, while also exhibiting a relatively low profile when not inflated. Further, the disclosed massage subassemblies are relatively low cost, and are relatively easy to manufacture and assemble.

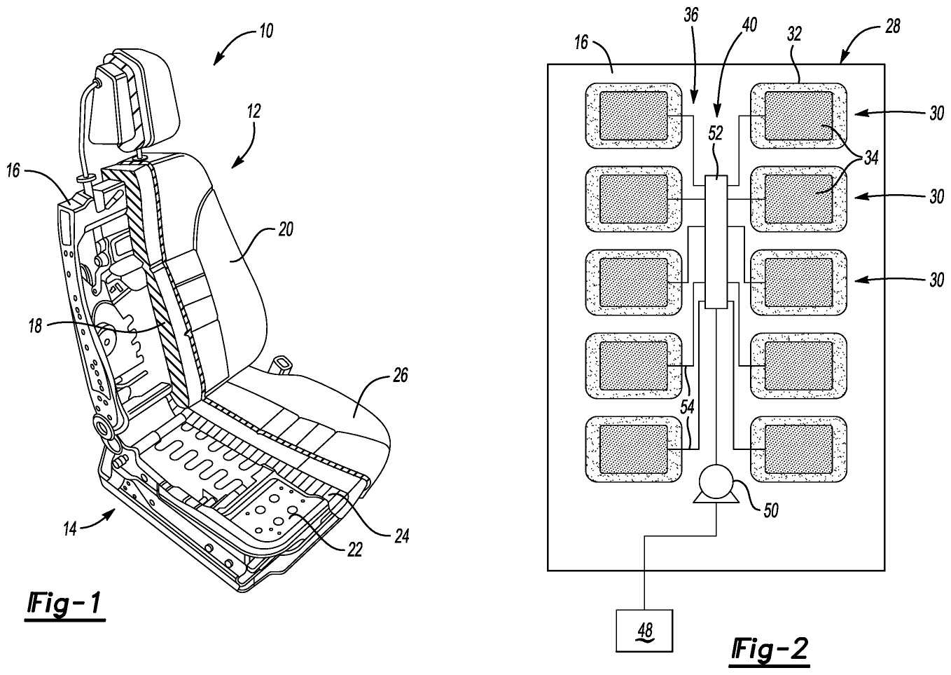

FIG. 1 illustrates an example seat 10 for an automobile. In this example, the seat 10 includes a seat back 12 and a seat base 14. The seat back 12 includes a seat frame 16. The seat frame 16 supports a cushion 18, which is covered by trim 20. The seat base 14 likewise includes a seat frame 22, which supports a cushion 24, which in turn is covered by trim 26.

While an automobile is mentioned, the seat 10 may be a seat for another type of vehicle, such as a motorcycle, watercraft, aircraft, and/or locomotive.

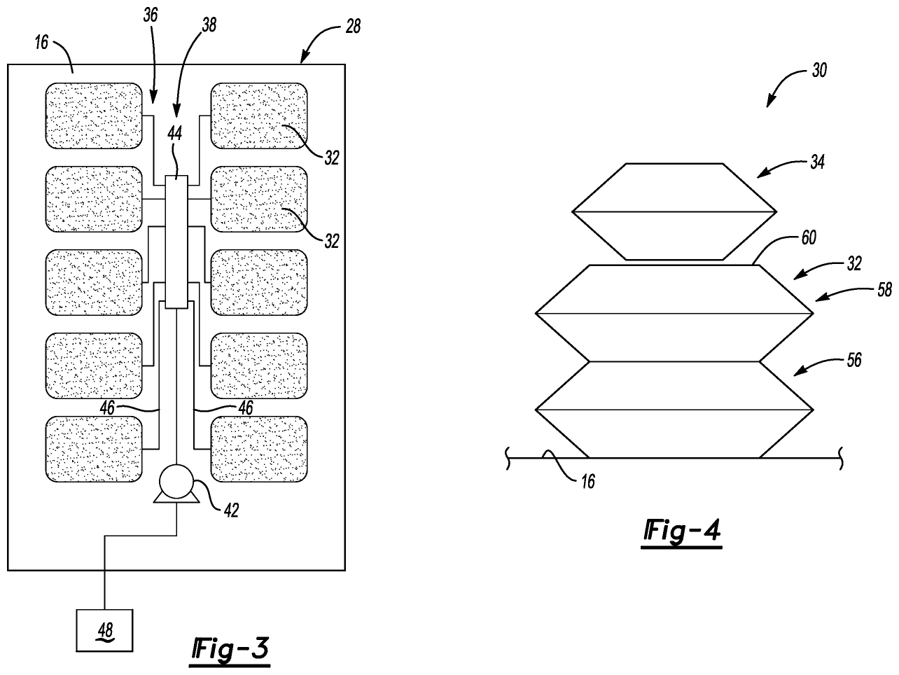

FIGS. 2 and 3 schematically illustrate an example system, which here is a first example massage assembly 28, relative to the seat frame 16 of the seat back 12. In particular, the massage assembly 28 is mounted to the seat frame 16 either directly or indirectly via a carrier board, which is mounted to the seat frame 16. While the massage assembly 28 is shown relative to the seat back 12, a substantially similar massage assembly could alternatively or additionally be implemented relative to the seat base 14.

The massage assembly 28 includes a plurality of massage subassemblies 30. There are ten massage subassemblies 30 in this example. While ten massage subassemblies 30 are shown, it should be understood that this disclosure extends to configurations with a different quantity of massage subassemblies. The massage subassemblies 30 are arranged in two columns, with five massage subassemblies in each column. This disclosure extends to other arrangements. The massage subassemblies 30 are spaced-apart vertically and laterally from one another to provide coverage relative to a back of a user, namely a person seated on seat 10.

In this example, as shown in FIG. 4, the massage subassemblies 30 each include a first bladder 32 and a second bladder 34. As will be discussed below, the first and second bladders 32, 34 are fluidly isolated from one another, such that fluid within the first bladder 32 does not intermix with fluid within the second bladder 34.

With reference back to FIGS. 2 and 3, the massage assembly 28 is configured to independently supply fluid to the first bladders 32 and the second bladders 34. The massage assembly 28, in this example, includes a fluid supply system 36 having two independently controllable subsystems 38, 40. A first subsystem 38 is configured to supply a first source of fluid, which is air in one example, to the first bladders 32. As shown in FIG. 3, the first subsystem 38 includes a pump 42, a valve assembly 44 including one or more valves, and a plurality of fluid passageways 46 fluidly coupling the pump 42, valve assembly 44, and the first bladders 32.

The pump 42 and valve assembly 44 are responsive to instructions from a controller 48 to selectively direct fluid to inflate or deflate one or more of the first bladders 32. The first bladders 32 are configured to be inflated and deflated according to a particular massage setting, which may be input by a user. The first bladders 32 may alternatively or additionally be inflated or deflated according to a predetermined massage pattern, which may be stored in the memory of the controller 48.

In an example, the valve assembly 44 is configured to selectively permit fluid to flow to each one of the first bladders 32 independently. Alternatively, in another example, the valve assembly 44 is configured to direct fluid to pairs of the first bladders 32 that are vertically aligned along the seat back 12, for example, independently. This disclosure extends to other configurations of the valve assembly 44.

The controller 48 may include a processing unit and non-transitory memory for executing various control strategies. The processing unit can be a custom made or commercially available processor, a central processing unit (CPU), or generally any device for executing software instructions. The memory can include any one or combination of volatile memory elements and/or nonvolatile memory elements. The processing unit can be programmed to execute one or more programs stored in the memory. The programs may be stored in the memory as software code, for example. The programs stored in the memory may include one or more additional or separate programs, each of which includes an ordered list of executable instructions for implementing logical functions associated with the massage assembly 28. While shown as a single controller, the controller 48 may be comprised of one or more controllers. The controller 48 may also be in communication with, and responsive to instructions from, another controller.

The second subsystem 40 is configured to supply a second source of fluid, which is air in one example, to the second bladders 34. As shown in FIG. 2, the second subsystem 40 includes a pump 50, a valve assembly 52 including one or more valves, and a plurality of fluid passageways 54 fluidly coupling the pump 50, valve assembly 52, and the second bladders 34. The pump 50 and valve assembly 52 are responsive to instructions from the controller 48 to selectively direct fluid to inflate or deflate one or more of the second bladders 34 according to a particular massage setting or massage pattern.

The valve assembly 52 is configured to selectively permit fluid to flow to each one of the second bladders 34 independently. Alternatively, in another example, the valve assembly 52 is configured to simultaneously direct fluid to all of the second bladders 34.

In this example, the pumps 42, 50 are separate, independently operated pumps, the valve assemblies 44, 52 are separate assemblies, and the fluid passageways 46, 54 are provided by separate passageways. Each of the pumps 42, 50, valve assemblies 44, 52, and fluid passageways 46, 54 are incorporated into the seat back 12, such as being mounted to the seat frame 16 either directly or via a carrier board.

FIG. 4 illustrates one of the massage subassemblies with the first bladder 32 fully inflated with the first source of fluid, and the second bladder 34 fully inflated with the second source of fluid. The first and second bladders 32, 34 are fluidly isolated such that fluid within the first bladder 32 does not intermix with fluid within the second bladder 34, and vice versa. In this way, the first and second bladders 32, 34 can be independently inflated and deflated to provide a desired massage effect.

In an example, the first and second bladders 32, 34 are each formed using at least two sheets of material, with the sheets of material attached to one another adjacent their perimeters. The sheets may be attached using adhesive or ultrasonic welding, as examples. The sheets may be rectangular or circular-shaped.

In this example, the first bladder 32 is an inflatable, hollow structure, and includes two inflatable sections. The first bladder 32 provides a chamber, which is a space within the first bladder 32 that can be filled with fluid. The chamber of the first bladder 32 includes two sections, in this example. Specifically, the first bladder 32 includes a first inflatable section 56 mounted either directly or indirectly to the seat frame 16, and a second inflatable section 58 projecting from the first inflatable section 56 in a direction opposite the seat frame 16. In this example, the first and second inflatable sections 56, 58 are fluidly coupled to one another, such that both the first and second inflatable sections 56, 58 are configured to be selectively inflated with the first source of fluid. Fluid from the first source intermixes within the first bladder 32 and fills both the first and second inflatable sections 56, 58, substantially simultaneously. In this regard, the first bladder 32 includes an internal hole or passageway fluidly coupling the first and second inflatable sections 56, 58.

The first and second inflatable sections 56, 58 exhibit a substantially equal fluid capacity, which is the maximum amount of fluid the first and second inflatable sections 56, 58 are configured to hold without stretching the material of the first bladder 32. The term substantially equal, as used herein, refers to the first and second inflatable sections 56, 58 having equal fluid capacities, within tolerances that one skilled in this art would deem acceptable. In another embodiment, the second inflatable section 58 exhibits a lesser capacity than the first inflatable section 56.

While the first bladder 32 includes first and second sections 56, 58 in this example, the first bladder 32 is not required to have two inflatable sections. This disclosure extends to arrangements in which the first bladder 32 has one or more inflatable sections.

The second bladder 34 is an inflatable, hollow structure. The second bladder 34 projects from the first bladder 32, and in particular projects from a surface 60 of the second inflatable section 58. The second bladder 34 includes a chamber configured to be filled with fluid. The capacity of the second bladder 34 is less than the first bladder 32, in this example. Further, in this example, the second bladder 34 exhibits a lesser capacity than each of the first and second inflatable sections 56, 58. The relatively smaller capacity of the second bladder 34 provides a relatively more intense massage effect compared to the relatively larger first and second inflatable sections 56, 58. Specifically, the second bladder 34 is able to deliver a massage intensity that is readily felt by an occupant through the trim 20, for example, which otherwise might tend to mitigate or absorb the forces from differently-sized or differently-shaped massage subassemblies. In this regard, the second bladder 34 may be considered to provide a boost, or booster-type, massage effect.

In one example, the second bladder 34 is directly attached to the surface 60, such as by using adhesive or ultrasonic welding. In another example, the second bladder 34 is positioned next to, and projects from, the surface 60 without being directly attached thereto.

In the example of FIG. 4, the second bladder 34 is formed separately from the first bladder 32. In another example, the first and second bladders 32, 34 could be integrally formed. When integrally formed, the structure providing the first and second bladders 32, 34 would exhibit a wall or other divider such that the first and second bladders 32, 34 would be fluidly isolated from one another.

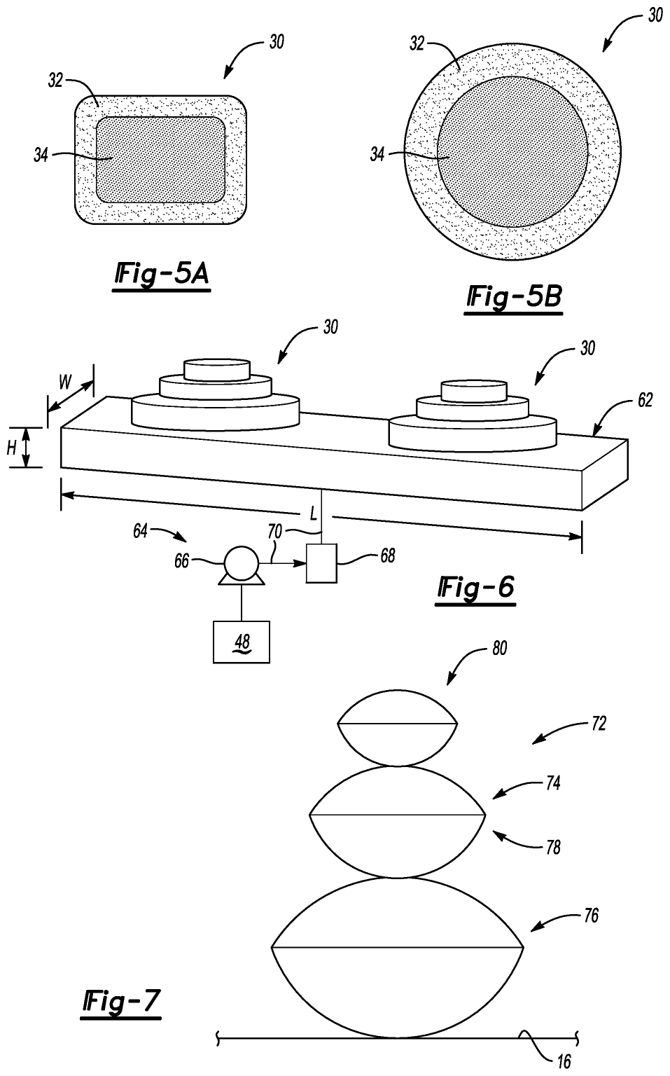

In an example, the capacity of the second bladder 34 is within 10-80% of the capacity of the first bladder 32. FIG. 5A illustrates a configuration in which the second bladder 34 exhibits a capacity 50% that of the first bladder 32. As the capacity of the second bladder 34 decreases, the force provided by the second bladder 34 becomes more concentrated to a smaller area, which provides a localized, intense massage.

As also shown in FIG. 5A, the first and second bladders 32, 34 are substantially rectangular-shaped when viewed from a top perspective. FIG. 5B also illustrates a configuration in which the second bladder 34 exhibits a capacity 50% that of the first bladder 32, but in FIG. 5B, the first and second bladders 32, 34 are circular-shaped when viewed from a top perspective. In FIG. 5B, the second bladder 34 is spherically-shaped when fully inflated.

The first and second bladders 32, 34 can be differently-shaped in some embodiments. For example, the first bladder 32 could exhibit a rectangular-shape, while the second bladder 34 could exhibit a circular-shape, both when viewed from top perspective. The circular-shape of the second bladder 34, coupled with the relatively smaller capacity of the second bladder 34, provides an even more localized, intense massage, as the contact point with an occupant of the seat 10 is provided by an apex of the rounded contour of the second bladder 34.

In an aspect of this disclosure, one or more of the massage subassemblies 30 project from a different type of massage subassembly. A different type of massage subassembly refers to a massage subassembly having a different capacity or shape, and configured to provide a different massage effect. In FIG. 6, two of the massage subassemblies 30 project from a different massage subassembly 62, which in this example exhibits both a greater capacity relative to the massage subassemblies 30 and exhibits a different shape relative to the massage subassemblies 30. The massage subassembly 62 is also configured to provide a different type of massage effect relative to the massage subassemblies 30. Generally, the massage subassembly 62 is a shaped substantially as a rectangular prism when inflated, with substantially rectangular sides, and overall exhibits a length L, width W, and height H. The massage subassembly 62 is configured to extend along the length of a calf of a user in the seat. In this aspect, the massage subassembly 62 is mounted adjacent the seat base 14, and in particular is mounted adjacent a front portion of the seat base 14. The size and shape of the massage subassembly 62, in this example, is such that the massage subassembly 62 is configured to provide a massage effect that is perceived by a user as a general sensation of squeezing the leg, and in particular the calf muscle. The massage subassemblies 30, on the other hand, can be selectively inflated independent of one another, and independent of massage subassembly 62, to provide a relatively more intense and concentrated massage to certain portions of the leg or calf. In this regard, the massage subassembly 62 is configured to be selectively inflated by fluid from a third fluid source, which is established by a third subsystem 64 of the fluid supply system 36, in this example. The third subsystem 64 includes a pump 66, a valve assembly 68, and a plurality of fluid passageways 70 fluidly coupling the pump 66 to the massage subassembly 62, as shown in FIG. 6. The pump 66 and valve assembly 68 are responsive to instructions from the controller 48 to direct the third fluid to inflate or deflate the massage subassembly 62. While two massage subassemblies 30 project from the massage subassembly 62, this disclosure extends to arrangements in which one or more massage subassemblies 30 project relative to the massage subassembly 62.

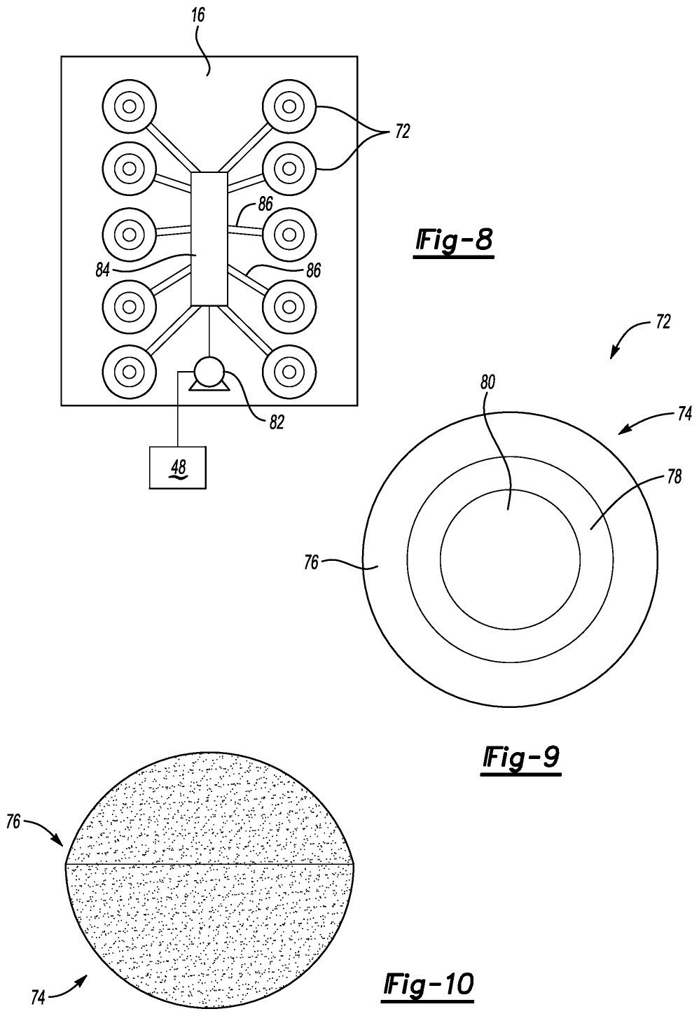

Another example massage subassembly 72 is shown in FIG. 7. The massage subassembly is provided by a single bladder 74, which includes a chamber having three inflatable sections 76, 78, 80. A plurality of the massage subassemblies 72 are mounted relative to the seat frame 16, as generally shown in FIG. 8. The massage subassemblies 72 are fluidly coupled to a pump 82, which is configured to supply fluid to the massage subassemblies 72 via a valve assembly 84 and a plurality of passageways 86, in response to instructions from controller 48. In this example, the inflatable sections 76, 78, 80 are circular-shaped when viewed from a top perspective, as shown in FIG. 9. As such, when fully inflated, as shown in FIG. 7, the inflatable sections 76, 78, 80 are substantially spherically-shaped.

In another aspect of this disclosure, the inflatable section 80 is shaped differently than the inflatable sections 76, 78, when inflated. In a specific example, the inflatable sections 76, 78 are made of rectangular-shaped pieces of material, whereas the inflatable section 80 is made of circular-shaped pieces of material, such that the inflatable section 80 is substantially spherically-shaped when inflated, whereas the inflatable sections 76, 78 resemble are substantially shaped as rectangular prisms.

In FIG. 7, the inflatable section 76, which is closest to the seat frame 16, exhibits a greater capacity than inflatable section 78 which projects from inflatable section 76. Further, inflatable section 78 exhibits a greater capacity than inflatable section 80, which projects from inflatable section 78.

The inflatable sections 76, 78, 80 are not fluidly isolated from one another in this embodiment. Rather, fluid intermixes within the bladder 74 and fills each of the inflatable sections 76, 78, 80 substantially simultaneously. In this regard, the first bladder 74 includes internal holes or passages fluidly coupling the inflatable sections 76, 78, 80.

While three inflatable sections 76, 78, 80 are shown, the massage subassembly 72 could include a single bladder providing having a chamber with one or more inflatable sections. In FIG. 10, the bladder 74 provides a single, spherically-shaped inflatable section 76.

The massage subassembly 72 could project from a different type of massage subassembly, such as a calf massager. For example, the massage subassemblies 30 in FIG. 6 could be replaced with massage subassemblies 72.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A system, comprising:
a first source of fluid;
a first bladder, wherein the first bladder is fluidly coupled to the first source of fluid and is configured to be selectively inflated with the first source of fluid;
a second source of fluid; and
a second bladder, wherein the second bladder is fluidly coupled to the second source of fluid and is configured to be selectively inflated with the second source of fluid, wherein the second bladder projects from a surface of the first bladder, and wherein the second bladder is fluidly isolated from the first bladder.

2. The system as recited in claim 1, wherein the second bladder is of a lesser capacity than the first bladder.

3. The system as recited in claim 1, wherein the first bladder includes a chamber including a first section and a second section.

4. The system as recited in claim 3, wherein the second section of the chamber is of a greater capacity than the second bladder.

5. The system as recited in claim 3, wherein the second section of the chamber is of a substantially equal capacity to the first section of the chamber.

6. The system as recited in claim 3, wherein the second section of the chamber is of a lesser capacity than the first section of the chamber.

7. The system as recited in claim 1, wherein the second bladder is integrally formed with the first bladder.

8. The system as recited in claim 1, wherein the second bladder is formed separately from the first bladder.

9. The system as recited in claim 1, wherein the first bladder exhibits a different shape than the second bladder when the first and second bladders are inflated.

10. The system as recited in claim 1, wherein the first and second bladders define a first massage subassembly for a seat.

11. The system as recited in claim 10, wherein the seat is a seat for an automobile.

12. The system as recited in claim 10, wherein the first massage subassembly is mounted to a second massage subassembly of a type different than the first massage subassembly.

13. A system, comprising:
a first massage subassembly including at least two inflatable sections; and
a second massage subassembly of a type different than the first massage subassembly, wherein the second massage subassembly is inflatable independent of the first massage subassembly, and wherein the first massage subassembly projects from a surface of the second massage subassembly.

14. The system as recited in claim 13, wherein the at least two inflatable sections include a first chamber and a second chamber, wherein a first bladder provides the first chamber, and a second bladder provides the second chamber, and wherein the first and second bladders are fluidly isolated from one another.

15. The system as recited in claim 13, wherein the at least two inflatable sections include a first section of a chamber and a second section of the chamber, and wherein the chamber is provided by a single bladder.

16. The system as recited in claim 13, wherein the at least two inflatable sections exhibit different shapes when inflated.

17. The system as recited in claim 16, wherein one of the at least two inflatable sections is shaped substantially as a rectangular prism when inflated.

18. The system as recited in claim 13, wherein the first massage subassembly is one of a plurality of first massage subassemblies projecting from the second massage subassembly, wherein each of the first massage subassemblies includes at least two inflatable sections.

19. A system, comprising:
a first inflatable section; and
a second inflatable section, wherein the first inflatable section exhibits a different shape than the second inflatable section when the first and second inflatable sections are inflated.

20. The system as recited in claim 19, wherein the second inflatable section is configured to be shaped substantially as a sphere when inflated.

21. The system as recited in claim 19, wherein the first inflatable section is a first chamber and the second inflatable section is a second chamber, wherein a first bladder provides the first chamber and a second bladder provides the second chamber, and wherein the first and second bladders are fluidly isolated from one another.

22. The system as recited in claim 19, wherein the first and second inflatable sections include a first section of a chamber and a second section of the chamber, wherein the chamber is provided by a single bladder.

23. The system as recited in claim 19, wherein the first and second inflatable sections are part of a first massage subassembly projecting from a surface of a second massage subassembly, wherein the second massage subassembly is of a different type than the first massage subassembly.
